(19) United States
(12) Patent Application Publication
(10) Pub. No.: US 2005/0076575 A1
(43) Pub. Date: Apr. 14, 2005

(54) Seal for refrigerator furniture units and the like, able in particular to compensate for manufacturing tolerances

(76) Inventors: Paolo Cittadini, Luvinate (IT); Adriano Merla, Angera (IT)

Correspondence Address: Abelman Frayne & Schwab, 150 East 42nd Street, New York, NY, 10017-5612, US

(21) Appl. No.: 10/497,353

(22) PCT Filed: Sep. 20, 2002
(86) PCT No.: PCT/EP02/10606

(30) Foreign Application Priority Data
Dec. 4, 2001 (IT) MI01A002548

(51) Int. Cl. E06B 7/22

(52) U.S. Cl. 49/498.1

(57) ABSTRACT

A seal (1) for refrigerator furniture units and the like, able in particular to compensate for manufacturing tolerance, is intended in particular for that kind of furniture unit in which the door (30) is preformed with an inner door (31) provided perimetrally with a male element (10), such as a projection, suitable for receiving a female seat (11) formed on the seal (1).

### CROSS-REFERENCE TO RELATED APPLICATIONS

This application is a 371 of PCT/EP02/10606, filed on Sep. 20, 2002.

### BACKGROUND OF THE INVENTION

1. Field of the Invention

The present invention relates to a seal for refrigerator furniture units and the like, able in particular to compensate for manufacturing tolerances.

2. Description of the Related Art

The Applicants themselves are proprietors of various patents relating to profiles for refrigerators supporting a seal. In particular it is possible to mention the patent U.S. Pat. No. 4,700,509 and the patent EP 319087 relating to seals of the magnetic type.

The German patent DE 3525538 (Bosch Siemens) describes a door for refrigerators, the inner door of which has a perimetral projection on which the bottom part of a magnetic seal engages. The door in this case is filled with thermal insulating material, generally a plastic foam, with assembly of the inner door performed for example by means of fixing screws. After assembly of the latter, the seal is applied to the said projection on the inner door by exerting a pressure on the bottom part thereof. The inner door and bottom part of the seal are both made from a rigid (albeit different) plastic material. According to this German patent the distance between the two ends of the bottom part, with a C-shaped cross-section, is chosen so as to be less than the width of the said projection on the inner door, which is tapered at the bottom. As a result of the pressure exerted, these ends are first deformed on the top of the projection and then return into position where the projection is tapered so as to perform fixing of the seal to the inner door.

In general, in the production of non-magnetic and magnetic seals for refrigerators and freezers it is always required to envisage certain tolerances with regard to the perimetral dimensions, the limits of which are agreed during the design stage by the refrigerator manufacturer and seal manufacturer so as to be able to compensate for any possible dimensional variation of the part with respect to the nominal dimensions, in particular during assembly on the inner doors and foaming of the doors. Moreover, the problem is often complicated by the presence of further dimensional tolerances during thermoforming of the inner doors.

For seals which use soft monoextruded profiles, generally a total tolerance range of 5 mm is applied.

In the case of profiles coextruded with rigid and soft materials, as in the case of abovementioned German patent, it is possible to apply very small tolerances, i.e. generally 3 mm. During design of these coextruded profiles it is therefore required to satisfy the requirement of assembling on the inner door of the furniture unit seals which must have perimetral dimensions within the redefined tolerance limits (3 mm). Since two rigid frames can in practice be joined together only by means of the respective nominal cross-sections, namely without tolerances, essentially for this reason the system proposed in the abovementioned German patent—in which both the inner door and the part (bottom part) of the seal intended for engagement therewith are made of rigid material with a very limited tolerance—does not appear to be applicable on an industrial level.

### BRIEF SUMMARY OF THE INVENTION

The object of the present invention is to provide a seal profile, in particular for refrigerators, freezers and the like, in which the seal must be fixed onto a preformed door provided with an inner door of the kind in which the latter has, running along one or more sides of its perimeter, a male element consisting of a projection which may or may not be tapered, for fixing said seal, where the dimensional tolerances usually envisaged during production may be compensated for in a secure and reliable manner.

In order to achieve this object, the present invention proposes a seal made of plastic for furniture units and the like provided with a door and an inner door fixed together by filling with foam the gap defined between them, performed for thermal insulation purposes, of the kind in which the said inner door is formed along one or more sides with a projection in the zone close to its end which is positioned over said door, said projection having the function of a male element for engagement with said seal, the latter having a bellows portion made of soft plastic material and forming a sealing closure between the door and the associated furniture unit, and a base able to engage with said projection on the inner door, characterized in that said base of the seal is made of rigid plastic material formed by means of coextrusion with said soft plastic material of the bellows portion and has a shape comprising a female portion substantially complementing that of said projection, defining for engagement therewith a seat between a central section and a pair of lateral sections, there extending, from the latter towards the inside of said seat for said projection, lips made of soft material elastically deformable such that at least a part of them interferes operationally with said projection so as to yield elastically thereon when said seal is fitted with pressure onto said projection and bear against it at the end of the movement, being stably fixed in a deformed position.

According to the invention, preferably said central section is substantially horizontal, whereas said lateral sections are substantially vertical and said lips are arranged to be inclined in the direction of said central section.

### BRIEF DESCRIPTION OF THE SEVERAL VIEWS OF THE DRAWINGS

So that it is possible to understand more clearly characteristic features and advantages of the invention, a non-limiting example of embodiment thereof is described below with reference to the figures of the accompanying drawings, in which:

FIG. 1 shows a cross-section through a seal according to the invention;

FIGS. 2 and 3 show similar views of the same seal which is operationally joined to an inner door of a refrigerator furniture unit, in the case of two different dimensional tolerances.

### DETAILED DESCRIPTION OF THE INVENTION

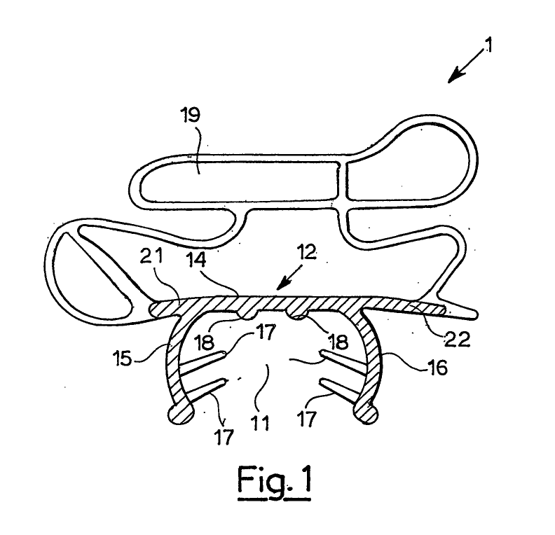

With reference to FIG. 1, a seal 1 according to the invention is made of coextruded plastic material: it in fact consists of a bellows portion 20 made of soft plastic material for forming a sealed closure with the refrigerator furniture unit. For this purpose the seal terminates at the top in a seat 19 for a magnetic insert. Said soft portion 20 is coextruded with a base 12 of the seal made of rigid plastic material, which has a female form with a seat 11 defined between a substantially horizontal central section 14 and a pair of substantially vertical lateral sections 15 and 16, there extending, from the latter towards the inside of said seat 11, lips 17 made of elastically deformable soft material and in turn coextruded with the base 12 made of rigid material. In the example considered here, the lips consist of two pairs of lips, each pair having a different width and being inclined in the direction of said central section of the base 12.

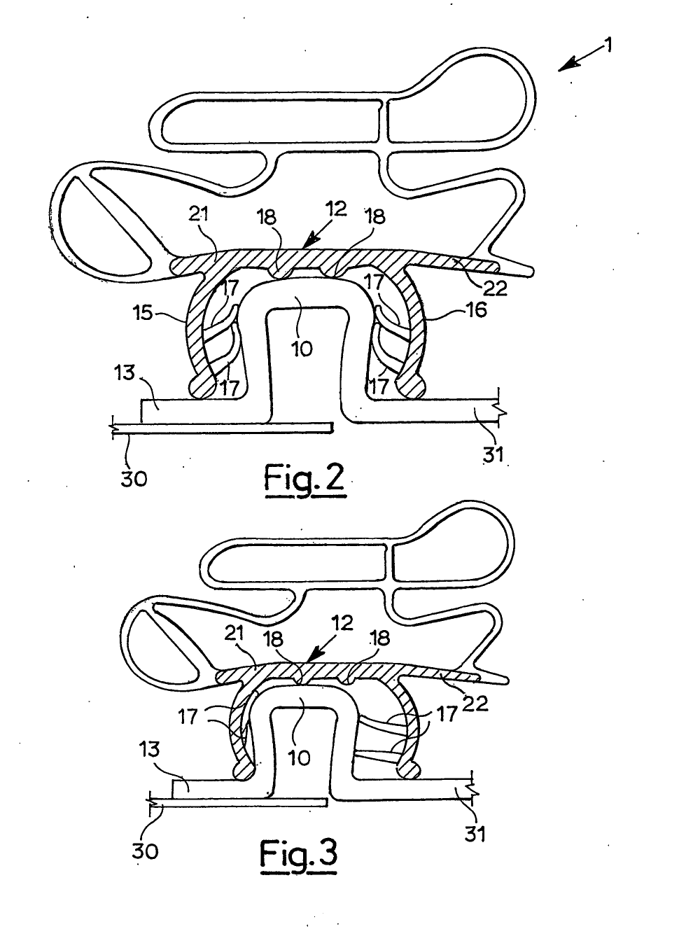

The said central section 14 extends on both sides beyond the sections 15 and 16 along end sections 21 and 22 on which the said soft bellows portion 20 is coextruded. The extension of said end sections 21 and 22, which operationally are at least slightly inclined towards the door of the furniture unit (see FIGS. 2 and 3), is variable as required depending on whether or not a greater extendibility of the bellows 20 is desired.

Ribs 18 acting as spacer or end-of-travel elements extend from the substantially horizontal section 14, still in the direction of the seat 11. In the example according to FIG. 1 said ribs are shaped directly on the base 12 made of rigid material. In a different embodiment of the invention, they may also be formed by means of coextrusion from soft material.

FIGS. 2 and 3 show the seal according to FIG. 1 which is operationally joined to an inner door 31 fixed to a door 30 of a refrigerator furniture unit, of the kind in which the said inner door 31 is formed along one or more sides with a projection 10 in the zone close to its end 13 which is positioned over said door 30, said projection 10 having the function of a male element for engagement with said seal. For assembly on the inner door, the seal 1 is fitted by means of pressure, exerted on the base 12 made of rigid material, along the projection 10. The dimensions of the base 12—and in particular the sections 15 and 16 and the associated lips 17—of the seal 1 cover a tolerance range so that in each case at least a part of said lips interferes operationally with said projection 10 so as to yield elastically thereon when said seal is fitted by means of pressure on said projection, and bear against it at the end of the movement, determined by resting of the ribs 18 on the upper surface of the projection 10, being stably fixed thereon in a deformed position, as shown in FIGS. 2 and 3.

When the seal becomes worn with time, it will nevertheless be possible to detach it from the inner door by applying a suitable force and replace it, fitting a new seal onto the projection 10.

FIG. 2 shows the seal according to FIG. 1 which is operationally joined to the male projection 10 in the case where the latter is located positioned at the center of the tolerance range envisaged by the female seat 11 and therefore in the case where there is no appreciable deviation between the actual and nominal dimension. In this situation the two pairs of lips 17 exert an opposing force on each of the two sides affected by engagement with the male element in a uniform manner, as demonstrated by their practically equal deformation on both sides.

FIG. 3, on the other hand, shows the seal according to FIG. 1 operationally joined to the male projection 10 in the case where the latter is located positioned at the tolerance limit envisaged by the female seat 11 and therefore in the case where there is effectively the maximum possible deviation between the actual and nominal dimension. In this situation, the two pairs of lips 17 exert an opposing force on each of the two sides affected by engagement with the male element in a non-uniform manner, as shown by their deformation which is practically total on one side of the projection 10 and more or less non-existent on the other side. This situation may occur at the minimum limit of the tolerance range.

In the opposite case where the perimetral dimension of the seal is at the maximum tolerance limit, there would be the reverse situation with a total deformation of the lips 17 on the opposite side of the projection 10 to that shown in FIG. 3, whereas on the other side—that shown in FIG. 3 where the lips are compressed and crushed against 10—they would be nearly inactive and almost in a rest position without appreciable deformation.

Not shown in the accompanying drawings, there are also various intermediate situations compared to the two limit situations shown above, where the tolerances present have values which in each case vary with associated deformation of the two pairs of lips which are correspondingly different on the two sides of engagement with the male element and increasingly less dissimilar, until the ideal situation shown in FIG. 2 is achieved.

Whatever the case, the seal according to the invention is able to compensate for any dimensional deviation which falls within the predefined tolerance range, allowing satisfactory stable positioning of the seal on the inner door. In fact it is essentially the opposing action of the tip of the lips which manage to interfere with the respective projection engaging side, which ensures satisfactory fixing of the seal, so much so that it would theoretically be sufficient for at least one lip from among those provided to assume this position acting against the male projection in order to ensure fixing of the seal to the inner door.

For this reason, the invention does not impose any limitations as regards the number or the arrangement of the lips inside the female seat of the base inside which they act. It is instead essential that they are positioned and dimensioned widthwise so that at least one of them is able to oppose with its tip the surface of the projection provided on the inner door despite the dimensional tolerances present.

It can therefore be understood how, according to the invention, the shape and the dimensions of this male element on the inner door are irrelevant and may therefore vary within a wide range since the seal according to the invention will in each case be designed and adapted to the specific projection in question and to the other specific features of the design as proposed by the refrigerator manufacturer, provided, however, that the fundamental teaching described above is respected.

Other variations with respect to that illustrated by way of example above may be envisaged for the shape of the seal, both as regards the bellows part made of soft material and as regards the base part made of rigid material, the latter being able to have a different shape both of the central section, the two lateral sections and the spacing ribs, provided that the essential technical effect as described above is respected. For example, it may be usefully envisaged that the ends 21 and 22 of the rigid base on which the soft part of the seal is coextruded extend lengthwise, in particular inclined in the direction of the inner door so as to allow greater extendibility of the bellows with respect to the specific embodiments shown in the accompanying drawings. In this case, therefore, the substantially horizontal central section of the rigid base has a breadth which is greater than that shown in the said examples and a shape slightly sloping towards the door of the furniture unit, while the female part of the base itself remains practically unvaried.

Moreover, despite the fact that seals of the magnetic type are shown in the examples, the invention may also be effectively applied also to seals of the non-magnetic type.

1. Seal (1) made of plastic for refrigerator furniture units and the like provided with a first door (30) and an inner door (31) fixed together by filling with foam the gap defined between them, performed for thermal insulation purposes, of the kind in which the said inner door (31) is formed along one or more sides with a projection (10) in the zone close to its end (13) which is positioned over said first door (30), said projection (10) having the function of a male element for engagement with said seal, the seal (1) comprising:
a bellows portion (20) made of soft plastic material and forming a sealing closure between the first door (30) and the associated furniture unit, and
a base (12) able to engage with said projection (10) on the inner door (31), wherein said base (12) of the seal (1) is made of rigid plastic material formed by means of coextrusion with said soft plastic material of the bellows portion (20) and has a substantially female shape complementing that of said projection (10), defining for engagement therewith a seat (11) between a central section (14) and a pair of lateral sections (15) and (16), there extending, from the latter towards the inside of said seat (11) for said projection (10), lips (17) made of soft material elastically deformable such that at least a part of them interferes operationally with said projection (10) so as to yield elastically thereon when said seal (1) is fitted with pressure onto said projection (10) and bear against it at the end of the movement, being stably fixed in a deformed position.

2. Seal according to claim 1, wherein said central section (14) is substantially horizontal and said lateral sections (15) and (16) are substantially vertical.

3. Seal according to claim 1, wherein said lips (17) are arranged to be inclined in the direction of said central section (14).

4. Seal according to claim 1, wherein said lips are coextruded with said base (12).

5. Seal according to claim 1, wherein one or more ribs (18) extend from said central section (14) in the direction of said seat (11).

6. Seal according to claim 5, wherein said ribs (18) are coextruded from soft plastic material.

7. Seal according to claim 1, wherein the ends (21,22) of said central section (14) of the said base (12) on which said soft plastic material of the bellows portion (20) is coextruded extend to be inclined in the direction of the said inner door (31) so as to allow a greater extendibility of the bellows.

8. (canceled)

9. A seal made of plastic for refrigerator furniture units and the like provided with a first door and an inner door fixed together by filling with foam the gap defined between them, performed for thermal insulation purposes, of the kind in which the inner door is formed along one or more sides with a projection in the zone close to its end which is positioned over the first door, the projection having the function of a male element for engagement with the seal, the seal comprising:
a bellows portion forming a sealing closure between the first door and the associated furniture unit, and
a base able to engage with the projection on the inner door, wherein the base of the seal is made of rigid plastic material formed by means of coextrusion with a material forming the bellows portion and has a substantially female shape complementing that of the projection, defining for engagement therewith a seat between a central section and a pair of lateral sections there extending from the latter towards the inside of the seat for the projection, lips made of soft material elastically deformable such that at least a part of them interferes operationally with the projection so as to yield elastically thereon when the seal is fitted with pressure onto the projection and bear against it at the end of the movement, being stably fixed in a deformed position.

10. The seal according to claim 9, wherein the central section is substantially horizontal and the lateral sections are substantially vertical.

11. The seal according to claim 9, wherein the lips are arranged to be inclined in the direction of the central section.

12. The seal according to claim 9, wherein the lips are coextruded with the base.

13. The seal according to claim 9, wherein at least one rib extends from the central section in the direction of the seat.

14. The seal according to claim 13, wherein the at least one rib is coextruded from soft plastic material.

15. The seal according to claim 9, wherein the ends of the central section of the base on which a soft plastic material of the bellows portion is coextruded extend to be inclined in the direction of the inner door so as to allow a greater extendibility of the bellows.
